(19) United States
(12) Patent Application Publication
(10) Pub. No.: US 2014/0089225 A1
(43) Pub. Date: Mar. 27, 2014

(54) Extendible Process Directory Model

(71) Applicants: Michael Volkmer, Heidelberg (DE); Erwin Rojewski, Bad Schoenborn (DE)

(72) Inventors: Michael Volkmer, Heidelberg (DE); Erwin Rojewski, Bad Schoenborn (DE)

(73) Assignee: SAP AG, Walldorf (DE)

(21) Appl. No.: 13/629,476

(22) Filed: Sep. 27, 2012

(51) Int. Cl. G06Q 10/06

(52) U.S. Cl. CPC G06Q 10/067
USPC 705/348

(57) ABSTRACT

A method includes using a computer to derive a design stage directory model based on a core directory model, using the computer to derive a production stage directory model based on the core directory model, adding an extension to one of the models including an activation flag to activate the extension, and saving the models and extension to a computer readable storage device.

### BACKGROUND

Businesses today use enterprise software systems to realize aspects of the business, such as everyday operations, controlling, reporting, human resources management, and so on. Activities of the business are modeled in the system and employees perform their tasks in the system. Enterprise software systems are implemented in the information technology landscape of a company within complex projects usually over the course of months or years. Projects may have several different stages, for example, design, implementation, upgrade, maintenance, and so on.

In each of these stages, objects that build up the system are copied from one stage to the next and are modified in the next stage according to the requirements of the system. As objects are modified in different project stages, there may be a need to track and compare the content of an object from one project stage to the content of an object in another project stage. Also, there may be a need to apply the content of an object in one project stage to the content of the object in another project stage. While models are used to facilitate tracking of objects, the models may contain attributes that are hard coded, and can be quite inflexible.

### SUMMARY

A method includes using a computer to derive a design stage directory model based on a core directory model, using the computer to derive a production stage directory model based on the core directory model, adding an extension to one of the models including an activation flag to activate the extension, and saving the models and extension to a computer readable storage device.

In one embodiment, a core directory model has a top level, and successive scenario level, process level, and process step levels. An extension to add a sub-node level beneath the process step level, the sub-node level identities a sender object type and a receiver object type (also referred to as parent/child object types), a cardinality, and an exclude flag to provide an option to hide an existing relation or object type via an extension in the sub-node level.

A system includes a programmed computer system having a module to provide an extension to a core directory model, the core directory model having a top level, and successive scenario level, process level, and process step level, wherein the extension adds a sub-node level beneath the process step level. The programmed computer system further includes a module to provide an extension to a design stage directory model and a production stage directory model, each derived from the core directory model and complying with selected compatibility criteria to facilitate transfer of instances based on the two models.

### BRIEF DESCRIPTION OF THE DRAWINGS

FIG. 1 is a block diagram illustrating a life cycle of a process according to an example embodiment.

FIG. 2 is a core directory model illustrating grouped scenarios according to an example embodiment.

FIG. 3 is a block diagram of models an model based environments according to an example embodiment.

FIG. 4 is a block diagram illustrating models and environments utilized to facilitate life cycle management according to an example embodiment.

FIG. 5 is a block diagram of models and model based environments with extensions according to an example embodiment.

FIG. 6A illustrates a top level of a core directory model according to an example embodiment.

FIG. 6B illustrates a scenario sub-structure of a core directory model according to an example embodiment.

FIG. 6C illustrates how a list of scenarios in a scenario group is defined in a core directory model according to an example embodiment.

FIG. 6D illustrates how a list of process steps within a process step group is defined in a core directory model according to an example embodiment.

FIG. 6E illustrates object type and attribute type relations in a core directory model according to an example embodiment.

FIG. 7A illustrates a customer process directory model extension of the core directory model according to an example embodiment.

FIG. 7B illustrates a top level folder of a customer process directory model extension of the core directory model according to an example embodiment.

FIG. 8 is a user interface illustrating a sample instance based on a core directory model according to an example embodiment.

FIG. 9 is a user interface illustrating a sample instance based on a customer process directory model extension of the core directory model according to an example embodiment.

FIG. 10 is a user interface illustrating an extension of the core directory model according to an example embodiment.

FIG. 11 is an interface illustrating a sample instance based on an extension of the core directory model according to an example embodiment.

FIG. 12 is an interface illustrating activation and layering of extensions to a directory model according to an example embodiment.

FIG. 13 is a user interface illustrating an extension for an object type-attribute type relation according to an example embodiment.

FIG. 14 is a user interface illustrating a model extension with a major structure change according to an example embodiment.

FIG. 15 is an example computer system having programming instruction stored on a machine readable storage device for cause the computer system to execute the methods and models according to an example embodiment.

### DETAILED DESCRIPTION

In the following description, reference is made to the accompanying drawings that form a part hereof, and in which is shown by way of illustration specific embodiments which may be practiced. These embodiments are described in specific detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The models, interfaces, functions, and algorithms described herein may be implemented in software or a combination of software and human implemented procedures in one embodiment. The software may consist of computer executable instructions stored on computer readable media such as memory or other type of computer readable storage devices. Further, such functions correspond to modules, which are software stored on storage devices, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Application lifecycle management software delivers different models and tool environments for models to customers and partners for use in managing enterprise application software implementing customer processes. Customers and partners can extend the provided models to their needs in client dependent extensions to the models. Many extensions to the same model may cause inconsistencies that may be avoided via extension priorities. If several extensions are used within one client, priorities may be used to uniquely calculate the correct model. for example, in one extension the “process step” object type is excluded, in another one it is included. Via the priority it can now be decided which of the two extension will “win”. Different models and extensions are possible due to the client concept that allows client-specific extensions. The priorities allow many customers to work with different models in the same system. The system may be provided in a stand alone or cloud-based environment. An activation tag may be provided for each extension, facilitating activation of different extensions in the same model for different clients.

A core model is provided that serves as the basis for other models. Instances that are derived from the core model are transferrable to instances based on other models. Thus, the other models are defined as variations of the core model so that it is possible to transfer instance data from one instance to another that are based on different models during the lifecycle of instances. For each model, different functionality may be provided. Therefore, the models are bound to environments that are used to provide desired features. In addition, an option to include non-core model based environments may be provided via external environments.

For each model, customer or partner specific extensions may be defined. The extensions may be client specific so that each client may provide different models for end users. Since the same model can have several extensions, a priority for the extensions is used to uniquely calculate a customer model.

Application lifecycle management software can deliver different models and tool environments for the models to customers and partners. The customers and partners can then extend the provided models to their needs in client dependent extensions. Many extensions to the same model may cause inconsistencies that are avoided via extension priorities. Thus, many customers can work with different models in the same system.

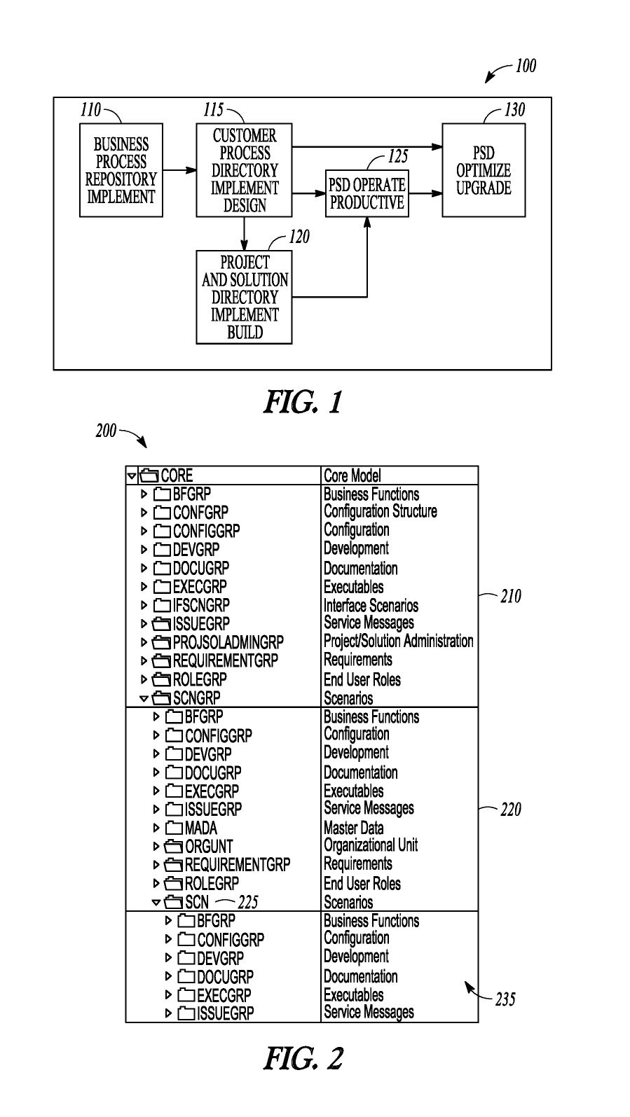

FIG. 1 is a block diagram of a life cycle model 100 of a process object in an example embodiment. A unified directory model based approach is used to model customer processes. The model may be changed via extensions by customers, yet still retain the ability to manage different versions of the objects associated with a life cycle of objects in the model. The model based directory facilitates management of process structures and associated content, such as documents and executables and other content during the lifecycle of the processes. In different phases of the lifecycle, variations of the model may be used since different content may be maintained. Main parts of the content are managed consistently through different lifecycle phases.

Life cycle model 100 shows different versions of a process existing during different portions of the lifecycle of processes. A business process repository (BPR) 110 is a pre-model implementation of a business process object. While it may not be part of the model in some embodiments, it is a predecessor of a model object. During a lifecycle, a BPR 110 object may change, or a new version of a BPR object might be delivered. Thus, a model object may be compared against its BPR predecessor object.

A customer process directory (CPD) object 115 is a design stage object. It is used to build a project and solution directory (PSD) object 120, and also a production version of the PSD object 125, which operates in the customer production environment. Finally, indicated at 130 is an upgraded version of the PSD object that is optimized.

FIG. 2 illustrates a core model generally at 200. Group object types are illustrated at 210. There are several group object types, including business functions, configuration structure, configuration, development, documentation, executables, interface scenarios, service messages, project/solution administration, requirements, end user roles and scenario group 215. Several group object types associated with the scenario group object type are illustrated at 220 within scenario group 215. The scenario object types track closely with the group object types in some embodiment. Other group objects may similarly have several different object types which are not shown. Several group object types associated with a scenario object type 225 are illustrated at 235, and include for example business functions, configuration, development, documentation executables, service messages, etc. Each scenario has processes assigned. In CPD for example, it is also possible to maintain processes in folders in parallel to scenarios.

To be able to copy process content that is based on a CPD model to the core model for use during lifecycle of the content, certain compatibility criteria are ensured by defining a common model kernel. The core model is defined that is the basis for all other models. Instances that are derived from the core model may be transferrable to all other models. Thus, other models are defined as variations of the core model.

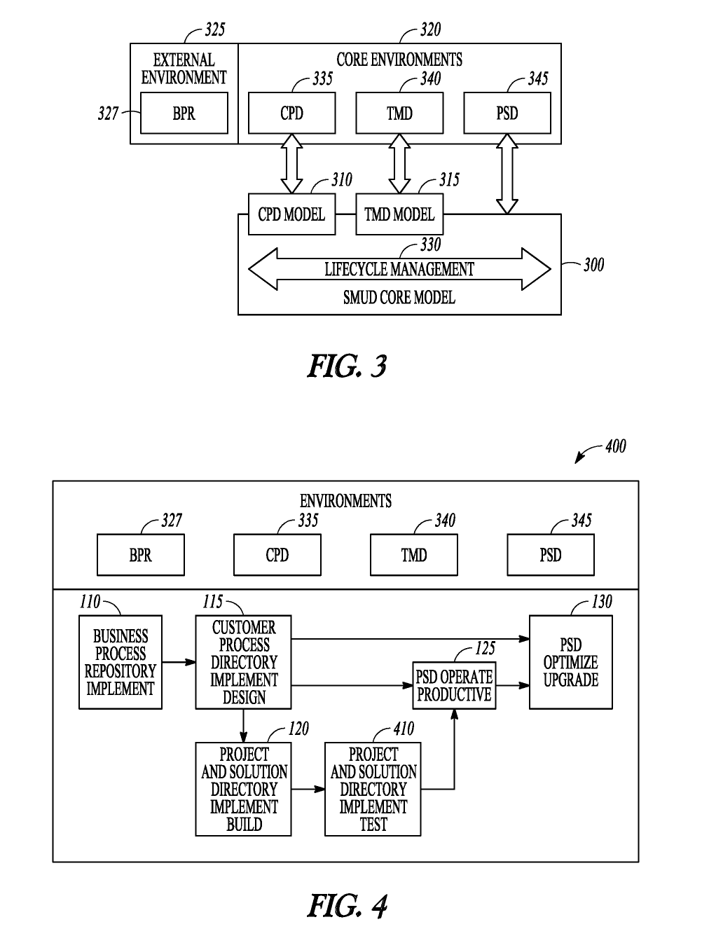

FIG. 3 is a block diagram illustration of core model 300 relationships with a CPD model 310 and a TMD model 315. For each model, different functionality may be provided. The models in one embodiment are bound to a core environment 320 that is used to provide desired features. In addition, an option to include non-core model based external environments 325 into lifecycle management 330 is provided via external environments 325. The core environment serves as a connecting part between the models 300, 310, 315 and provide functions for the models and lifecycle management 330.

In the external environment 325, a BPR environment 327 is provided. It provides for BPR objects which are not part of the core model directory, but may be predecessors of the core model objects. During the lifecycle, a BPR object might change or a new version of a BPR object might be delivered. Thus, it is possible to compare a core object against it BPR predecessor object.

The core environment 320 in one embodiment contains a CPD environment 335, TMD environment 340, and PSD environment 345. CPD environment 335 is based on a separate model in one embodiment so that it is possible to organize the CPD objects in a different way than objects of a project or solution. TMD objects are based on a separate model in one embodiment to mirror the differences to a normal implementation. Templates may be maintained and assigned in this environment. PSD environment 345 is based on the core model 300 that is the basis of all directory models. CPD and TMD are variations of the core model.

Core environments 320 that are based on core directory models have a corresponding assignment so that it is clear which functionality is needed. External environments 325 may not be based on a core directory model (e.g. BPR). In this case, a mapping to the core directory model is used so that it is possible to transfer objects from those external environments to core directory model-based environments. Further models and environments may be defined and integrated, such as for example a test environment with a test model.

The following example illustrated at 400 in FIG. 4 shows how environments and models may be used to support a flexible lifecycle management. It is similar to the life cycle model 100 with a version container from FIG. 3 added. Like components are consistently numbered. A PSD test model 410 has been added. Each box in the lifecycle model 400 in the lower portion of FIG. 4 represents an option to manage a version 410 of an object within the box. Thus the figure shows an option to manage an additional “test version” of the object that is managed in a PSD environment.

Since many customers have their own process structure, customers are allowed to make extensions to the core directory models without contradicting the lifecycle management aspects. Therefore, customer extensions may be limited to fit into the core directory model/environment concept without compromising the needed flexibility. An extension methodology allows changing the core directory models by excluding the relation between an object type and an attribute type, excluding the relation between an object type and another object type, adding new object types and attribute types, adding the relation between an object type and an attribute type, and adding the relation between an object type and another object type. In one embodiment, key fields that are used by lifecycle management may not be changed.

A model extension is defined for a core directory model. Thus, an extension of the core model has an impact on all models; whereas; an extension of one of the other models has an impact on the corresponding model. This ensures that the lifecycle management will work for extensions of Core model objects.

For one model, several extensions may exist. A partner may define an extension of the core model and a customer may further add some additional extensions to the Core model. In such a case, a priority for the extensions may be defined so that it is possible to calculate the correct model including all extensions.

Since it might be desired to have different versions of one model in one system (e.g. because different departments or customers work within one system with different requirements), the extension can be switched on and off per client.

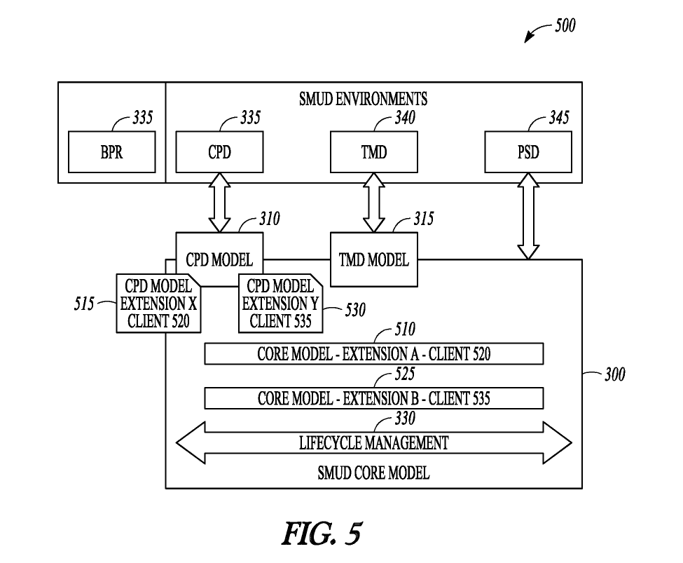

FIG. 5 illustrates such model extensions at 500. Like components are similar numbered as in previous figures. Two extensions are available for the core 300 and the CPD model 310. Extension A and Extension X are defined at 510 and 515 for client 520. The two other extensions 525, 530 are applied in client 535. This concept may be used in a cloud-based environment so that it is possible to host different customers with different models in one system.

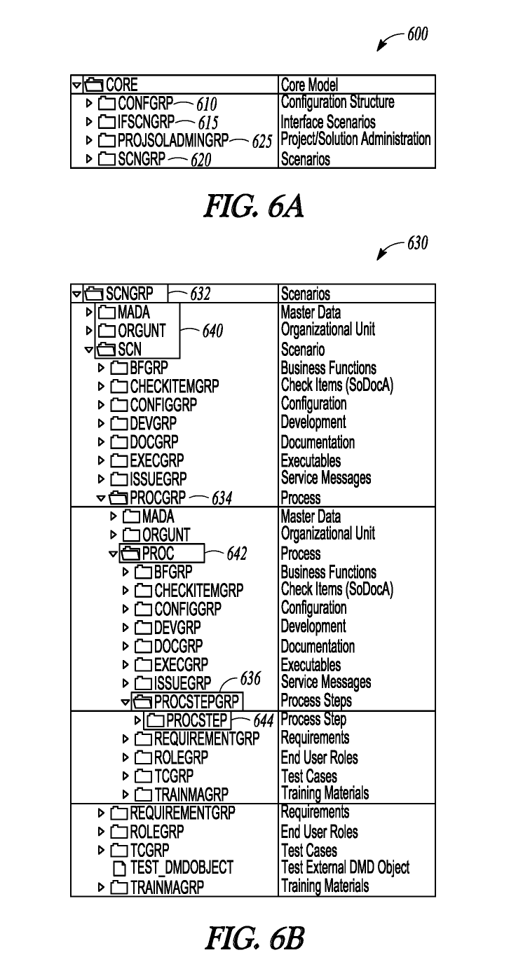

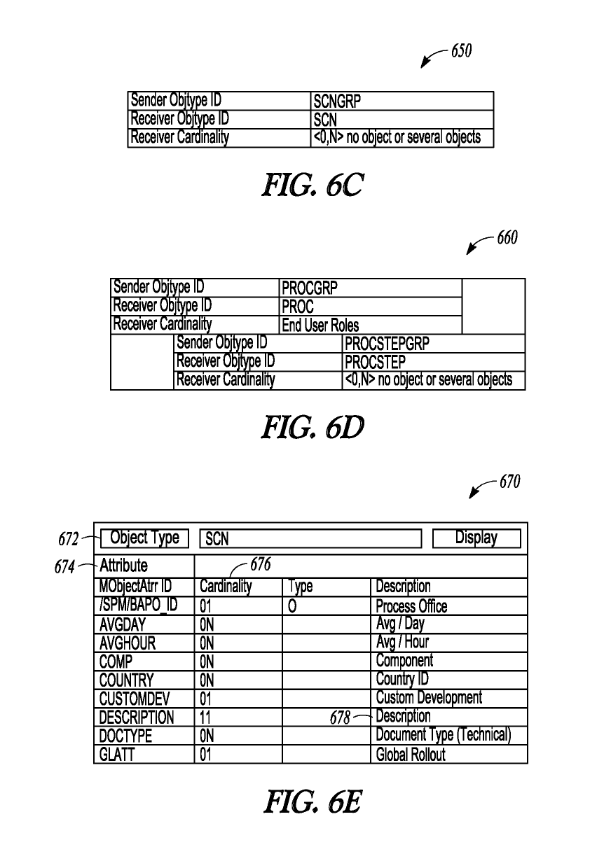

An excerpt from a top level of an example core directory model is illustrated at 600 in FIG. 6A. On the top level, the core directory model consists of 3 sub-structures, a Configuration Structure 610, Interface Scenarios 615, and Scenarios 620. In addition, Project/Solution Administration 625 provides standards (e.g. status values and document templates).

A scenario substructure is illustrated at 630 in FIG. 6B. The scenario sub-structure 630 consists of structure group nodes 632, 634, 636 and structures nodes 640, 642, 644. In the model, a sender/receiver cardinality is used to describe that a scenario group 632 consists of a list of scenarios as shown at 650 in FIG. 6C. This is maintained as a sender/receiver cardinality. Within a scenario there exists a list of processes with process steps 644 as shown at 660 in FIG. 6D. Sender/receiver cardinality may also be referred to as a parent/child relationship.

Object type and attribute type relations in the core directory model are illustrated at 670 in FIG. 6E. Each object type 672, a scenario in this case, can have several attribute types 674 assigned with a cardinality 676 that determines how many attributes can be associated on instance level. For example, a scenario has exactly one description 678 and can have a list of countries assigned.

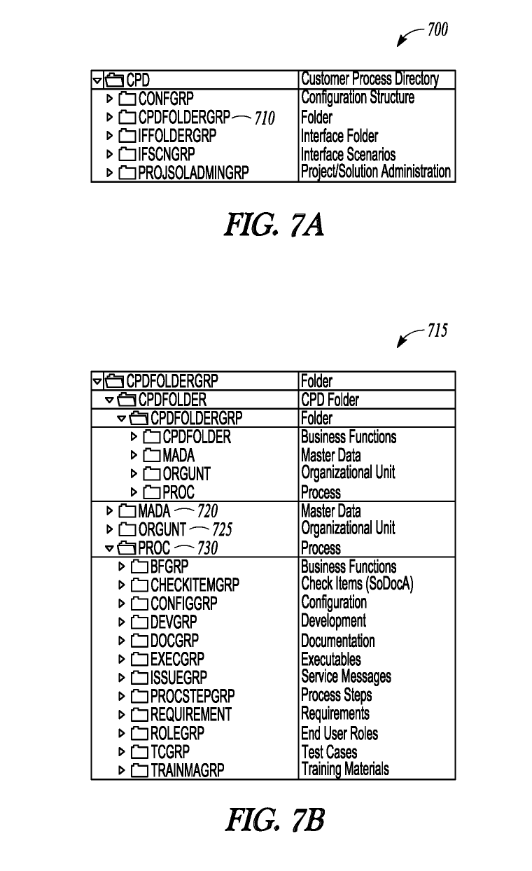

FIGS. 7A and 7B illustrate a customer extension to the core directory model. On the top level 700, parts of the core directory model are hidden. For example, the scenario group (SCNGRP) object type with all sub-nodes is hidden.

Instead a new top level CPD Folder (CPDFOLDERGRP) at 710 is introduced. The CPD Folder structure is shown in further detail at 715 in FIG. 7B. The structure provides for organization of Master Data (MADA) 720, Organizational Units (ORGUNT) 725 and Processes (PROC) 730 in a folder structure with arbitrary depth. In one embodiment, a folder can again have a folder as a sub-node.

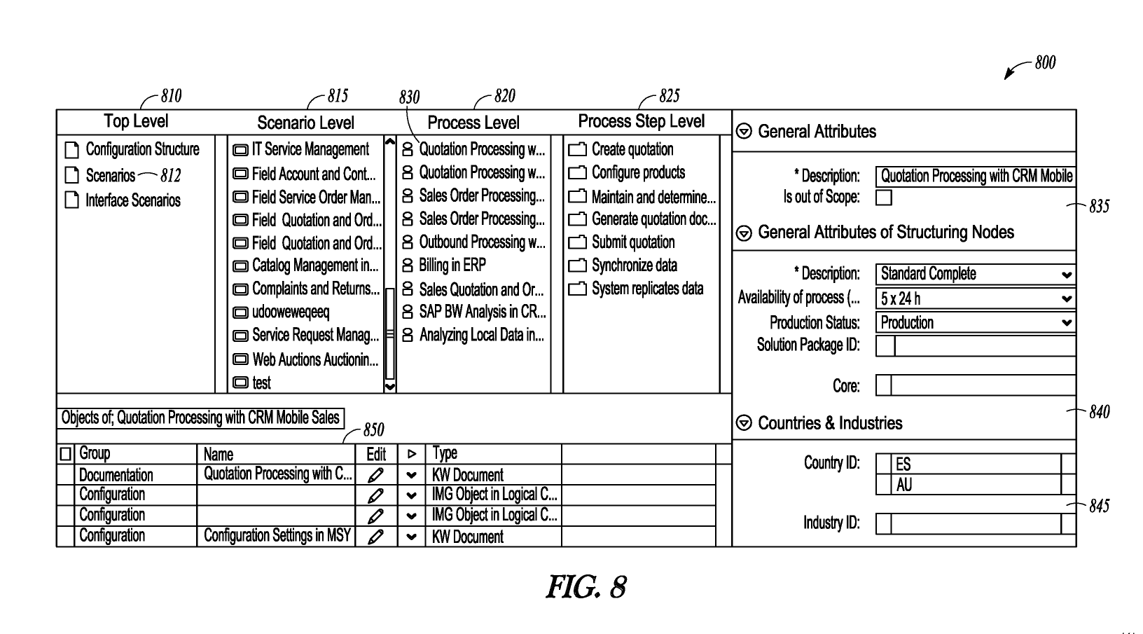

FIG. 8 is a graphical interface illustrating a sample instance at 800 that is based on the core model. Four levels are illustrated, a top level 810 with Scenarios 812 selected, the corresponding scenario level 815, with Field Quotation and Ord . . . 817 selected, the corresponding process level 820 showing processes associated with the selected scenario, and a process step level 825 indicating processes steps associated with a selection of quotation processing with CRM mobile sites at 830 from process level 820. General attributes of quotation processing with CRM model sites 830 are illustrated at 835, including a description and a checkbox for indicating if it is out of scope. General attributes of structuring nodes 840 are also provided, as well as a countries and industries section 845 to identify country IDs and industry IDs. At 850, objects belonging to quotation processing with CRM mobile sites are listed by group, name, editing constructs and types.

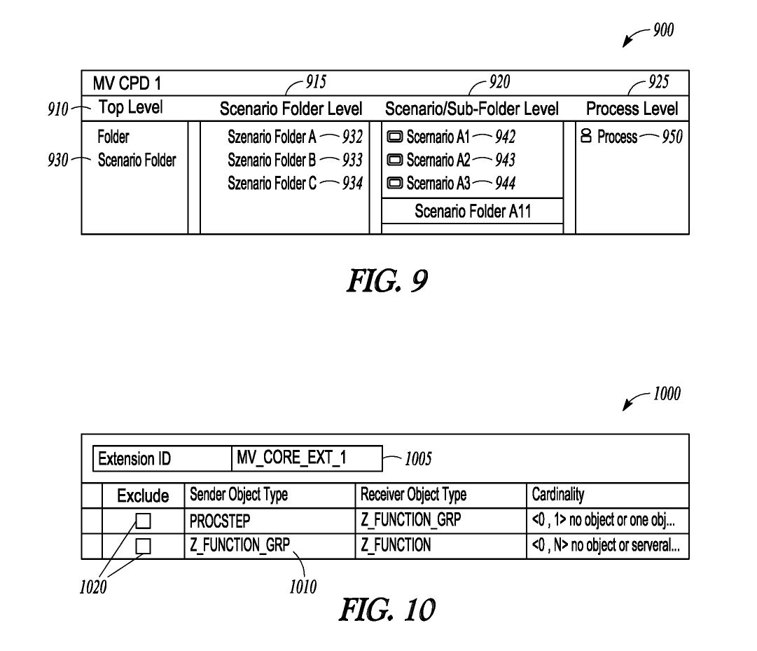

FIG. 9 is an example interface illustrating a sample instance that is based on a CPD model at 900. The model 900 includes a top level 910, scenario folder level 915, scenario sub-folder level 920, and process level 925. The top level 910 illustrates a selected scenario folder 930, resulting in folders 932, 933, and 934 being displayed in the scenario folder level. Scenario Folder A at 932 is shown as selected, resulting in three scenarios 942, 943, and 944 being shown in the scenario sub-folder level 920. Scenario A1 at 942 is shown as selected, resulting in process 950 being displayed in the process level 925.

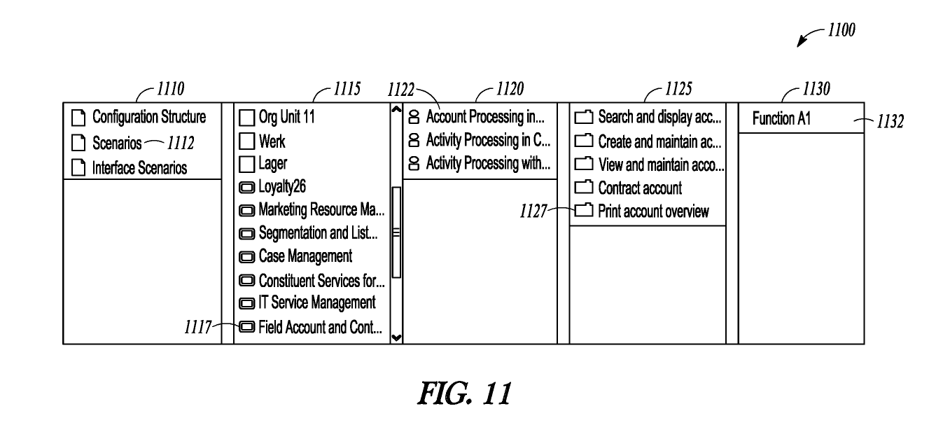

FIG. 10 illustrates a user interface displaying a representation of an extension 1000 of the core directory model. An extension ID, MV_CORE_EXT_{—}1, is illustrated at 1005. With this extension, it is possible to enhance the structure by one level underneath the process step. Z_FUNCTION_GRP 1010 is introduced as a sub-node of PROCSTEP 1015. Each Z_FUNCTION_GRP is associated with a list of Z_FUNCTION. Thus, on an instance level, each process step can have a list of functions underneath. A user is given the option to exclude sub-nodes from the selected model via checkboxes 1020.

FIG. 11 is a sample instance 1100 based on the extension MV_CORE_EXT_{—}1 of the core directory model. Instance 1100 illustrates a top level 1110 with a scenario 1112 selected. A scenario level 1115 shows several different scenarios with a field account and cont . . . 1117 selected. A process level 1120 shows an account processing in . . . 1122 selected, resulting in a process step level 1125 illustrating several process steps with Print account overview 1127 selected. A further level 1130 has been added to provide a list of functions associated with a selected process step. In this instance, Function A1 at 1132 is shown. A list of functions is now available under process step, which was previously the lowest level.

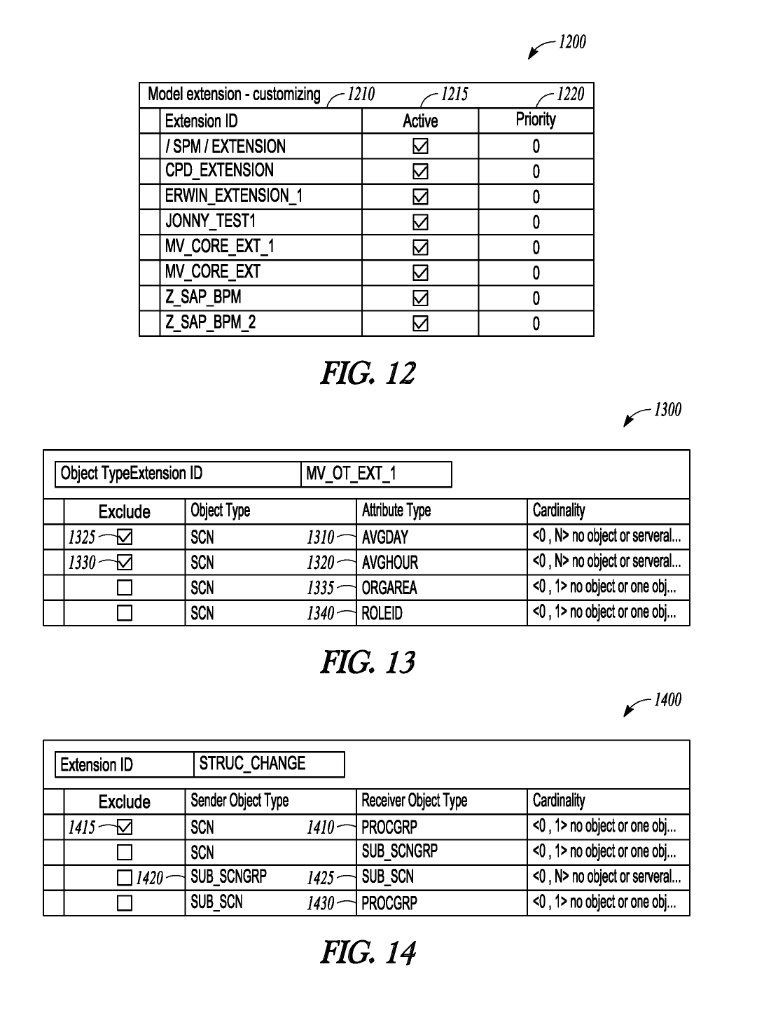

FIG. 12 is an interface 1200 illustrating activation and layering of extensions. Extensions are listed by extension ID 1210. An extension is activated by removing an activation flag 1215 by means of a checkbox. This flag activates the extensions in the selected client (tenant). Therefore, it is possible to activate different extensions for the same model in different clients. Thus, the same system can mange different core models based on the activations of the extensions in the corresponding clients.

In one embodiment, there can be several extensions for the same model in the same client. One example includes when a partner makes an extension for the core model and a customer also makes an extension for the core model on top of the partner extension. In this case, a priority 1220 may be defined for the extensions so that the final model may be uniquely determined.

FIG. 13 illustrates an example extension for an object type-attribute type relation at 1300. Two attribute types AVGDAY 1310 and AVGHOUR 1320 are excluded from object type scenario (SCN) as indicated at check boxes 1325, 1330. Two new attribute types (ORGAREA 1335, ROLEID 1340) are added to SCN. Such extensions may be defined as model independent, where the extension is valid for all models, or may be model specific, such that the extension is valid for a selected model. In general, the functionality is similar to the object-object type extensions, including priority, exclude, client-dependency, etc. The exclude flag within a model provides an option to “hide” an existing relation, providing the ability to remove such relations from the model.

FIG. 14 illustrates an model extension with a major structure change at 1400. With this extension, a new level for sub-scenarios is inserted between scenarios and processes and the process group is moved underneath the sub-scenarios. Object type PROCGRP 1410 is excluded at 1415 as a child node of scenario (SCN). A new group for sub-scenarios (SUB_SCNGRP 1420) is inserted as a new child node of scenario (SCN) that has sub-scenarios as child nodes (SUB_SCN 1425). Underneath the sub-scenario object type the process group object type (PROCGRP 1430) is inserted.

In some embodiments, parts of the model may be protected. In one embodiment, an object type-object type relation or object type-attribute type relation may be protected. Such protection ensure that certain parts of the model may not be changed.

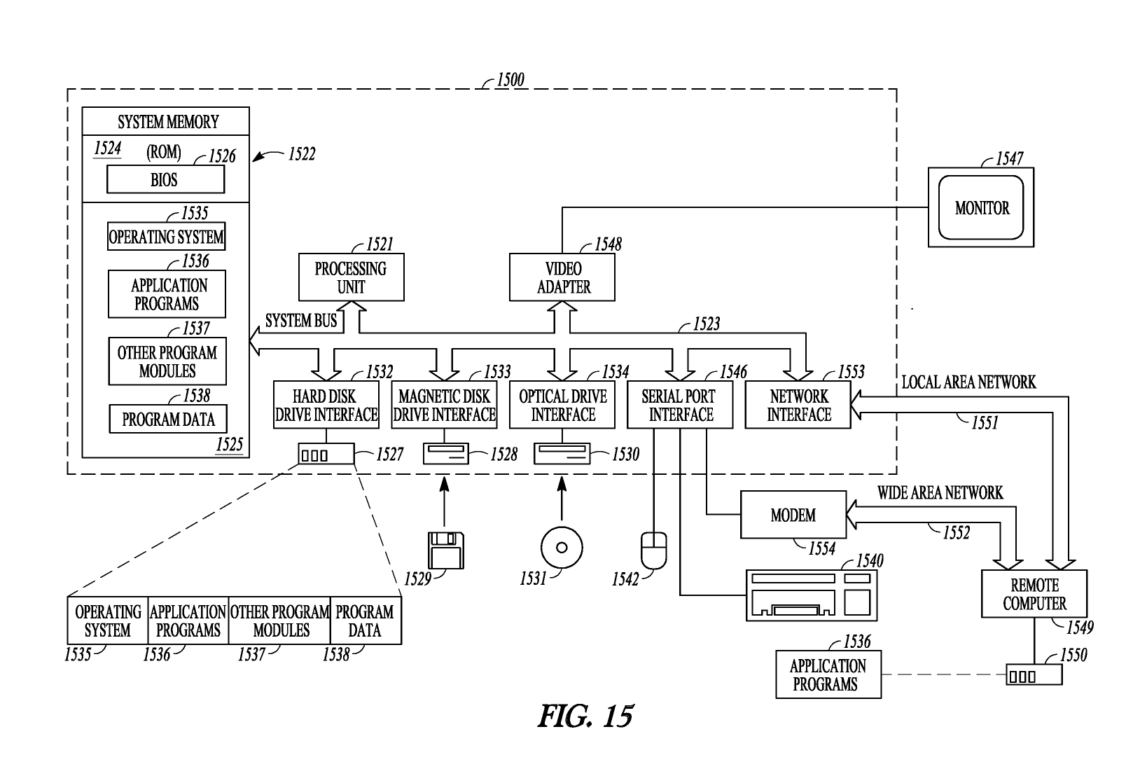

FIG. 15 is a block diagram of a computer system to facilitate model creation and lifecycle management aspects according to example embodiments. In the embodiment shown in FIG. 15, a hardware and operating environment is provided that is applicable to any of the models and interfaces shown in the other Figures. In some embodiments, the computer system may be implemented in a cloud based environment with resources assigned as needed.

As shown in FIG. 15, one embodiment of the hardware and operating environment includes a general purpose computing device in the form of a computer 1500 (e.g., a personal computer, workstation, or server), including one or more processing units 1521, a system memory 1522, and a system bus 1523 that operatively couples various system components including the system memory 1522 to the processing unit 1521. There may be only one or there may be more than one processing unit 1521, such that the processor of computer 1500 comprises a single central-processing unit (CPU), or a plurality of processing units, commonly referred to as a multiprocessor or parallel-processor environment. In various embodiments, computer 1500 is a conventional computer, a distributed computer, or any other type of computer.

The system bus 1523 can be any of several types of bus structures including a memory bus or memory controller, a peripheral bus, and a local bus using any of a variety of bus architectures. The system memory can also be referred to as simply the memory, and, in some embodiments, includes read-only memory (ROM) 1524 and random-access memory (RAM) 1525. A basic input/output system (BIOS) program 1526, containing the basic routines that help to transfer information between elements within the computer 1500, such as during the start-up, may be stored in ROM 1524. The computer 1500 further includes a hard disk drive 1527 for reading from and writing to a hard disk, not show, a magnetic disk drive 1528 for reading from or writing to a removable magnetic disk 1529, and an optical disk drive 1530 for reading from or writing to a removable optical disk 1531 such as a CD ROM or other optical media.

The hard disk drive 1527, magnetic disk drive 1528, and optical disk drive 1530 couple with a hard disk drive interface 1532, a magnetic disk drive interface 1533, and an optical disk drive interface 1534, respectively. The drives and their associated computer-readable media provide non volatile storage of computer-readable instructions, data structures, program modules and other data for the computer 1500. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 1529, optical disk 1531, ROM 1524, or RAM 1525, including an operating system 1535, one or more application programs 1536, other program modules 1537, and program data 1538. Programming for implementing one or more processes or method described herein may be resident on any one or number of these computer-readable media.

A user may enter commands and information into computer 1500 through input devices such as a keyboard 1540 and pointing device 1542. Other input devices (not shown) can include a microphone, joystick, game pad, satellite dish, scanner, or the like. These other input devices are often connected to the processing unit 1521 through a serial port interface 1546 that is coupled to the system bus 1523, but can be connected by other interfaces, such as a parallel port, game port, or a universal serial bus (USB). A monitor 1547 or other type of display device can also be connected to the system bus 1523 via an interface, such as a video adapter 1548. The monitor 1547 can display a graphical user interface for the user. In addition to the monitor 1547, computers typically include other peripheral output devices (not shown), such as speakers and printers.

The computer 1500 may operated in a networked environment using logical connections to one or more remote computers or servers, such as remote computer 1549. These logical connections are achieved by a communication device coupled to or a part of the computer 1500; the invention is not limited to a particular type of communications device. The remote computer 1549 can be another computer, a server, a router, a network PC, a client, a peer device or other common network node, and typically includes many or all of the elements described above I/O relative to the computer 1500, although only a memory storage device 1550 has been illustrated. The logical connections depicted in FIG. 15 include a local area network (LAN) 1551 and/or a wide area network (WAN) 1552. Such networking environments are commonplace in office networks, enterprise-wide computer networks, intranets and the internet, which are all types of networks.

When used in a LAN-networking environment, the computer 1500 is connected to the LAN 1551 through a network interface or adapter 1553, which is one type of communications device. In some embodiments, when used in a WAN-networking environment, the computer 1500 typically includes a modem 1554 (another type of communications device) or any other type of communications device, e.g., a wireless transceiver, for establishing communications over the wide-area network 1552, such as the internet. The modem 1554, which may be internal or external, is connected to the system bus 1523 via the serial port interface 1546. In a networked environment, program modules depicted relative to the computer 1500 can be stored in the remote memory storage device 1550 of remote computer, or server 1549. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### EXAMPLES

### Example 1

A computer readable storage device having a data structure stored thereon, the data structure comprising:
a core directory model having a top level, and successive scenario level, process level, and process step level; and
an extension to add a sub-node level beneath the process step level, the sub-node level identifying a sender object type, a receiver object type, a cardinality, and an activation flag to activate selected extensions in the sub-node level.

### Example 2

The storage device of example 1 wherein the data structure further comprises a design stage directory model and a production stage directory model, each derived from the core directory model.

### Example 3

The storage device of any of examples 1-2 wherein the design stage directory model and the production state directory model each comply with selected compatibility criteria to facilitate transfer of instances based on different models between instances.

### Example 4

The storage device of any of examples 1-3 and further comprising an external environment to facilitate use of a business process model that is not derived solely from the core directory model.

### Example 5

The storage device of any of examples 1-4 and further comprising a core environment to maintain and assign templates to the design stage directory model and production stage directory model.

### Example 6

The storage device of any of examples 1-5 wherein the production stage directory model supports a build stage, productive stage, and upgrade stage.

### Example 7

The storage device of any of examples 1-6 wherein an extension comprises an a additional version of an object managed in a production stage environment.

### Example 8

The storage device of any of examples 1-7 wherein the data structure further comprises how a list of scenarios in a scenario group is defined in a model including a sender/receiver cardinality for each scenario in the list of scenarios.

### Example 9

The storage device of any of examples 1-8 wherein the data structure further comprises object types, with an object type having several attribute types with a cardinality that determines how many attributes are associated on an object instance level.

### Example 10

The storage device of any of examples 1-9 wherein the data structure further comprises a top level folder extension to a design stage directory model to facilitate organization of master data and processes in a folder structure with arbitrary depth.

### Example 11

The storage device of any of examples 1-10 wherein an instance based on the core directory model includes a top level, a scenario level, a process level, and a process step level, and wherein an extension to the core directory model adds a list of functions in a level below the process step level.

### Example 12

The storage device of any of examples 1-11 wherein the data structure further comprises a design stage directory model derived from the core directory model, the design stage directory model including a top level, a scenario folder level, a scenario sub-folder level and a process level.

### Example 13

A method comprising:
deriving a design stage directory model based an a core directory model via a specifically programmed computer processor;
deriving a production stage directory model based on the core directory model via the specifically programmed computer processor;
adding an extension to one of the models including an activation flag to activate the extension; and
saving the models and extension to a computer readable storage device.

### Example 14

The method of example 13 wherein the design stage directory model and the production state directory model each comply with selected compatibility criteria to facilitate transfer of instances derived from the core directory model between instances based on the two models.

### Example 15

The method of any of examples 13-14 wherein the production stage directory model supports a build stage, productive stage, and upgrade stage.

### Example 16

The method of any of examples 13-15 and further comprising:
using the computer to generate an external environment to facilitate use of a business process model that is not derived solely from the core directory model; and
using the computer to generate a core environment to maintain and assign templates to the design stage directory model and production stage directory model.

### Example 17

A system comprising:
a programmed computer system having a module to provide an extension to a core directory model, the core directory model having a top level, and successive scenario level, process level, and process step level, wherein the extension adds a sub-node level beneath the process step level;
the programmed computer system further having a module to provide an extension to a design stage directory model and a production stage directory model, each derived from the core directory model and complying with selected compatibility criteria to facilitate transfer of instances derived from the core directory model between instances based on different models.

### Example 18

The system of example 17 wherein the programmed computer system comprises computing resources in a cloud based computing environment.

### Example 19

The system of any of examples 17-18 wherein an extension includes an activation flag to activate selected extensions.

### Example 20

The system of any of examples 17-20 wherein an extension includes an additional version of an object managed in a production stage environment.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer readable storage device having a data structure stored thereon, the data structure comprising:
a core directory model having a top level, and successive scenario level, process level, and process step level; and
an extension to add a sub-node level beneath the process step level, the sub-node level identifying a sender object type, a receiver object type, a cardinality, and an activation flag to activate selected extensions in the sub-node level.

2. The storage device of claim 1 wherein the data structure further comprises a design stage directory model and a production stage directory model, each derived from the core directory model.

3. The storage device of claim 2 wherein the design stage directory model and the production state directory model each comply with selected compatibility criteria to facilitate transfer of instances based on different models between instances.

4. The storage device of claim 2 and further comprising an external environment to facilitate use of a business process model that is not derived solely from the core directory model.

5. The storage device of claim 4 and further comprising a core environment to maintain and assign templates to the design stage directory model and production stage directory model.

6. The storage device of claim 2 wherein the production stage directory model supports a build stage, productive stage, and upgrade stage.

7. The storage device of claim 6 wherein an extension comprises an additional version of an object managed in a production stage environment.

8. The storage device of claim 1 wherein the data structure further comprises how a list of scenarios in a scenario group is defined in a model including a sender/receiver cardinality for each scenario in the list of scenarios.

9. The storage device of claim 1 wherein the data structure further comprises object types, with an object type having several attribute types with a cardinality that determines how many attributes are associated on an object instance level.

10. The storage device of claim 2 wherein the data structure further comprises a top level folder extension to a design stage directory model to facilitate organization of master data and processes in a folder structure with arbitrary depth.

11. The storage device of claim 1 wherein an instance based on the core directory model includes a top level, a scenario level, a process level, and a process step level, and wherein an extension to the core directory model adds a list of functions in a level below the process step level.

12. The storage device of claim 1 wherein the data structure further comprises a design stage directory model derived from the core directory model, the design stage directory model including a top level, a scenario folder level, a scenario sub-folder level, and a process level.

13. A method comprising:
deriving a design stage directory model based on a core directory model via a specifically programmed computer processor;
deriving a production stage directory model based on the core directory model via the specifically programmed computer processor;
adding an extension to one of the models including an activation flag to activate the extension; and
saving the models and extension to a computer readable storage device.

14. The method of claim 13 wherein the design stage directory model and the production state directory model each comply with selected compatibility criteria to facilitate transfer of instances derived from the core directory model between instances based on the two models.

15. The method of claim 14 wherein the production stage directory model supports a build stage, productive stage, and upgrade stage.

16. The method of claim 13 and further comprising:
using the computer to generate an external environment to facilitate use of a business process model that is not derived solely from the core directory model; and
using the computer to generate a core environment to maintain and assign templates to the design stage directory model and production stage directory model.

17. A system comprising:
a programmed computer system having a module to provide an extension to a core directory model, the core directory model having a top level, and successive scenario level, process level, and process step level, wherein the extension adds a sub-node level beneath the process step level;
the programmed computer system further having a module to provide an extension to a design stage directory model and a production stage directory model, each derived from the core directory model and complying with selected compatibility criteria to facilitate transfer of instances derived from the core directory model between instances based on different models.

18. The system of claim 17 wherein the programmed computer system comprises computing resources in a cloud based computing environment.

19. The system of claim 17 wherein an extension includes an activation flag to activate selected extensions.

20. The system of claim 17 wherein an extension includes an additional version of an object managed in a production stage environment.
